(19) United States
(12) Patent Application Publication
(10) Pub. No.: US 2014/0035369 A9
(43) Pub. Date: Feb. 6, 2014

(54) POWER SUPPLY APPLIANCE AND POWER SUPPLY SYSTEM WITH AN APPLIANCE SUCH AS THIS

(71) Applicants: Gerhard Wolff, Blomberg (DE); Christoph Leifer, Bad Driburg (DE)

(72) Inventors: Gerhard Wolff, Blomberg (DE); Christoph Leifer, Bad Driburg (DE)

(73) Assignee: PHOENIX CONTACT GMBH & CO. KG, Blomberg (DE)

(21) Appl. No.: 13/877,659

(22) PCT Filed: Oct. 5, 2011
(86) PCT No.: PCT/EP11/67412

§ 371 Date: May 22, 2013

(30) Foreign Application Priority Data
Oct. 5, 2010 (DE) 102010037995.6

(51) Int. Cl. G05F 1/10

(52) U.S. Cl. CPC G05F 1/10
USPC 307/31; 323/234

(57) ABSTRACT

The object of the invention is a power supply device (12) having a control and/or regulating unit (22), a reference potential connection (26), at least one voltage potential connection (28), and a ground connection (30) for grounding the power supply device (12). It is provided that the power supply device has a permanent or switchable device internal short-circuit current path (40) between the reference potential connection (26) and the ground connection (30), a detection device (44) for the continuous or quasi-continuous detection of a current flowing through the short-circuit current path (46), which connects the detection device (44) with the control and/or regulating unit (22) in a signal technical manner. The invention further relates to a respective power supply system (10).

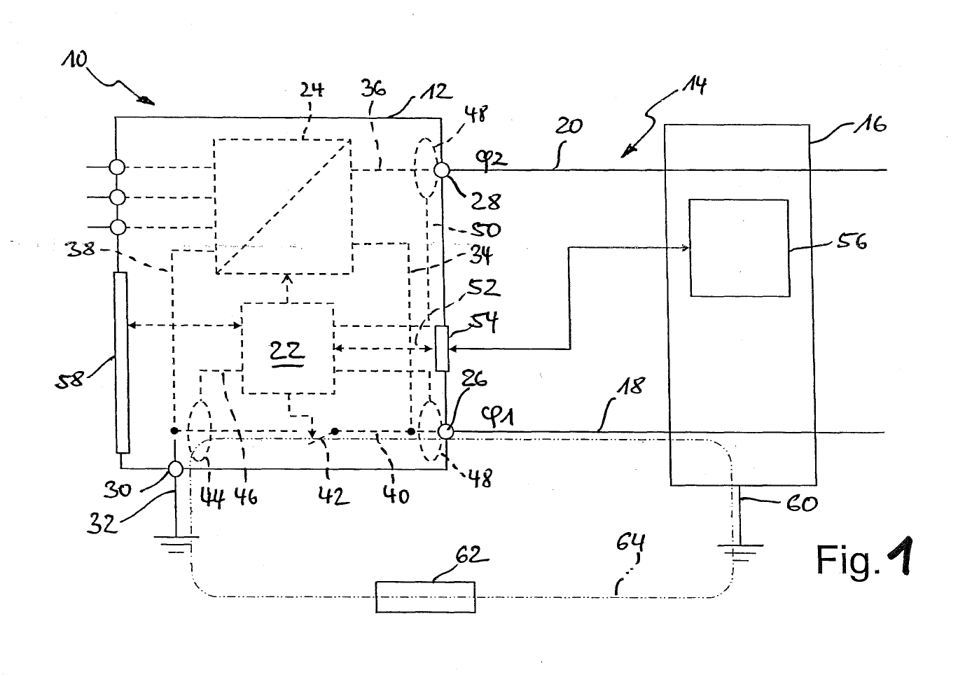

The invention relates to a power supply device having a control and/or regulating unit, a reference potential connection, at least one voltage potential connection, and a grounding connection for grounding the power supply device. The invention further relates to a power supply system having a power supply device.

Such a power supply device is known, for example, as a central power supply device for a power network, or another electric circuit of a system. The control and/or regulating unit serves primarily for the control or regulating of a characteristic of the power supply unit (e.g. the voltage).

For safety reasons, and for reasons of system availability, the machinery directive stipulates among others, that a first insulation error must already be recognized in the control system of a machine or a system, and may not result in a faulty behavior of the machine or system. A typical first error is, for example, the fraying of a sensor cable. If a cable falls on top of a metal machine carrier and frays such that active, signal carrying lines come into temporary or permanent electric contact with this machine carrier, then—for lack of suitable disclosure mechanisms for recognizing the first error—a second error, for example the fraying of another active, signal carrying line, would lead to the associated control recognizing these insulation errors as an active sensor signal without any difference to a knowingly actuated command. Thereupon an erroneous function of a machine or a system could be actuated, which may lead to personal injury or system damage.

Such typical first errors are disclosed in practice, for example, in that at a central location in the electrical cabinet a line of the control system being on reference potential, for example, on mass, is grounded. In the case of an error as described above the control-internal line protection is actuated in this case. The machine or system is switched off immediately after the occurrence of the insulation error in this manner, and thus protected from any erroneous functions.

The current caused by the insulation error may, with an existing connection between the reference potential of the control and the ground, flow through the electric circuit in this manner. The safety organs of the control are actuated with professional dimensioning.

Alternatively, in systems, in which a connection between the ground and the reference potential of the control is not desired, a permanent insulation monitoring is carried out. In this manner a “first” insulation error of active signal lines is recognized, and may be reported. Operation is not interrupted unexpectedly. There is enough time for troubleshooting. This operating mode after a first insulation error corresponds to a system with grounded reference potential. Only a second insulation error of the opposite potential leads to an immediate shutoff.

When taking a closer look at the high-voltage current installation of these systems in practice, one very often finds current distribution systems that have grown over decades, which have rarely been adapted to the requirements of modern electric infrastructures. This is the case in particular, when with the capacity expansion of systems the high-voltage current supply thereof is constant being expanded, however not professionally renovated. This is often the case in industrial nations, but even more so in countries having a less pronounced industrial structure. In those countries TN-C-power supply systems, or mixed TN-C-S systems are still found. In the TN-C system the return conductor of the low voltage system (neutral conductor) carrying the operating current is together with the earth conductor as the PEN conductor embodied in one mutual wire. At each connection joint of the PEN conductor with the potential equalization system or the grounding system, part of the current flowing back for the feed will leave the PEN conductor and enter into the grounding system. In this manner earth potential differences, among others, are generated between the different system parts. Inevitably, these will result in compensating currents via electrically conductive structures being connected in parallel to the same. These potential differences are in turn also a source for interference currents in the technical control parts of systems. They may be verified in case of the presence of multiple grounds of the reference potential of the control system as a compensation current between the reference potential of the 24 V control system (e.g. system mass, 0 V, GND) and the earth system. These currents also flow in the mass lines in this manner.

These compensation currents lead to over-proportional aging, stress, or even a hazard for all electronic components of the control system, and may result in undefined voltage peaks, destructions, or hardly verifiable system failures, for example, in case of a change in installation (in an extreme case this may be the plugging in of a diagnostic plug of a serial interface of a PC).

In order to avoid these phenomena which have a strong adverse effect on system availability, the connection between system mass and ground may generally be carried only one single time in a self-contained system part. It must be ensured—also in the interests of the system operator—that this mode is maintained over the entire operating duration of the system.

According to prior art differential currents are available within the power supply system, i.e. the electric circuit of the system, which compare the in and out flowing currents. Any deviating values of the in and out flowing currents mean that leakage currents flow, and a first error is present.

Furthermore, so-called insulation monitors are available, which monitor in a non-one-sidedly grounded, insulated control system between the power supply and the earth, whether the system specific minimum insulation values are being maintained, or whether a drop of the insulation resistance is being determined.

Both solutions are technically very extensive and cost-intensive. These devices must be projected, planned, installed, and monitored.

The invention is therefore based on the object of providing a power supply unit and a power supply system which enables the detection of external currents within the power network in a reliable and simple manner.

The solution of the task is carried out according to the invention by means of the characteristics of claims 1 and 13. Advantageous embodiments of the invention are stated in the sub-claims.

The power supply device according to the invention has a permanent or switchable device internal short-circuit current path between the reference potential connection and the ground connection, a detection device for the continuous or quasi-continuous detection of a current flowing through the short-circuit current flow, and a signal trans-mission path connecting the detection device with the control and/or regulating unit in a signal technical manner.

The reference potential connection and the ground connection of the power supply device are—as naturally also the voltage potential connection—external connections of the device. These two connections are electrically connected to each other in a device internal manner via a permanent or switchable short-circuit current path. The current flowing through this short-circuit current path may be detected by means of the detection device, wherein a signal of the control and/or regulating unit of the device, which is proportional to said current, may be transmitted. The same may therefore monitor the power network being supplied by the power supply device on any external currents entering into the first line path via the ground connection.

Preferably, the short-circuit current path is a switchable short-circuit current path. If this short-circuit current path is not switched on, voltage measurements are possible between the reference potential and the ground potential.

According to an advantageous embodiment of the invention the detection device is an all current sensitive detection device with the dynamics of a continuous or quasi-continuous detection, comprising a frequency range of 0 Hz to at least 1 MHz. In this manner high-frequency external currents may also be detected in the power network supplied by the power supply unit. Such high-frequency external currents are mostly generated by means of line capacities and/or device capacities of the lines, and/or the electric devices switched in the power network by means of these lines opposite of the earth potential at different locations.

According to a further advantageous embodiment of the invention it is provided that the power supply device further has at least one additional detection device for the continuous or quasi-continuous detection of a current flowing through the reference potential connection and/or the voltage potential connection. Preferably, the additional detection device is also an all current sensitive detection device, the dynamics of which comprises a frequency range of 0 Hz to 20 kHz, preferably of 0 Hz to 100 kHz.

In particular, it is provided that the additional detection device is connected with the control and/or regulating unit in a signal technical manner via the additional signal transmission path.

According to an additional advantageous embodiment of the invention it is provided that the control and/or regulating unit monitors the chronological correlation between the current detected in the short-circuit current path and the detected current flowing through the voltage potential connection continuously, or quasi-continuously. Due to this monitoring the control and/or regulating unit may differentiate the effects of operational current and/or voltage peaks of actual external currents.

According to an advantageous embodiment of the invention it is provided that the power supply device has at least one interface being connected with the control and/or regulating unit in a signal technical manner. By means of this/these interface(s) the control and/or regulating unit may assume regulating and control functions within the power network/electric circuit supplied by the power supply unit. For this purpose the control and/or regulating unit may be connected with a higher instance of the power network or of the system, and/or with control systems of electric devices being switched within the power network, such as electric machines, in a signal technical manner via the interface.

For this purpose it is preferably provided that the at least one interface is embodied as an analog interface and/or a digital interface. If the interface is a digital interface, it is provided in particular that this digital interface is embodied as an RS232, RS485 and/or RS422 interface.

According to an advantageous embodiment of the invention it is provided that the control and/or regulating unit monitors the chronological correlation between the current detected in the short-circuit current path and the signals of the interface continuously, or quasi-continuously. By means of this monitoring the control and/or regulating unit may also differentiate the effects of operational current and/or voltage peaks of actual external currents.

According to a preferred embodiment of the invention the control and/or regulating unit is embodied as a microprocessor. The detection or the monitoring, respectively, may be easily implemented in a control and/or regulating unit that is embodied as a microprocessor. It is provided in particular that the microprocessor comprises the analog/digital converter and/or the digital/analog converter required for the signal transmission.

It is provided in particular that the control and/or regulating unit compares the detected or monitored actual values to the target values.

According to an advantageous embodiment of the invention it is provided that the power supply device has at least one output unit that is connected with the control and/or regulating unit in a signal technical manner. By means of this output unit an output may occur, for example, as a function of the comparison result between the actual and target values. The output unit may be, for example, an acoustic output unit for the output of a warning tone, an optical output unit, such as a warning lamp or a display, or any other interface for the output of a signal to another unit.

The invention further relates to a power supply system having an above mentioned power supply device and a power network, comprising at least two line paths, and at least one electric device, wherein the electric device is supplied with power by the power supply device via the line paths.

According to an advantageous embodiment of the power supply system according to the invention it is provided that a control device of the electric device and/or a control and/or regulating device of the power network is connected with the control and/or regulating unit in a signal technical manner via the interface. The control and/or regulating device of the power network is, in particular, an instance superior to the control device of the electric device and of the control and/or regulating unit of the power supply device.

The invention is explained in further detail below with reference to the attached drawings based on preferred embodiments.

They show

FIGURE a power supply system having a power network comprising an electric device to be supplied and two line paths, and a power supply unit according to a preferred embodiment of the invention.

The FIGURE shows a power supply system 10 with a central electric power supply unit 12 for feeding electric power into a power network 14 of the power supply system 10. Multiple electric devices 16 are switched in the power network 14 (of which, however, only one is illustrated). These electric devices 16 are supplied with power by the power supply unit 12. The power network 14 is embodied as a DC power network 14, and has two line paths 18, 20. At the first line path 18 a reference potential φ1 embodied as a negative potential (“minus potential”) is applied, and at the second line path 20 a potential (“plus potential”) φ2 that is higher than the reference potential φ1 is applied for generating an operating current by means of the power network 14. The potential difference (Δφ=φ2−φ1) between the two potentials φ1, φ2 is essentially constant, since the power supply device 12 has a control and/or regulating unit 22, which regulates this potential difference, or voltage, respectively. The power network 14 is therefore a power network 14 driven by a constant voltage.

In addition to the control and/or regulating unit 22 the power supply device 12 has, for controlling or regulating a power supply unit 24 being embodied as a converter, three external connections 26, 28, 30 being connected with said unit in an electrically conductive manner. One of the connections is a reference potential connection 26 connected to the first line path 18, another of the connections is a voltage potential connection 28 connected to the second line path 20, and another of the connections is a ground connection 30 for grounding the power supply device 12. For this reason this ground connection 30 is connected to earth potential via an earth current path 32 at one location. Internal of the devices the external connections 26, 28, 30 are connected with respective outlets of the power supply unit 24 via respective current paths 34, 36, 38.

The control and/or regulating unit 22 of the power supply device is—as is common with modern control and/or regulating units—embodied as a microcontroller (μC). In addition to the processor this microcontroller also has work and program memories, and preferably also peripheral units, such as analog/digital converters and/or digital/analog converters. By means of these peripheral units the microcontroller may communicate with other units within or outside of the power supply device 12.

The power supply device 12 further has a switchable device internal short-circuit current path 40 between the reference potential connection 26 and the ground connection 30. For this purpose a switch 42 is disposed in the short-circuit current path 40, which is embodied as a switch device, which may be actuated by the control and/or regulating unit 22.

Furthermore, the power supply device 12 comprises a detection device 44 for the continuous, or quasi-continuous detection of a current flowing through the short-circuit current path 40. This detection device 44 is connected with the control and/or regulating unit 22 in a signal technical manner by means of a signal transmission path 46 for transmitting a signal characterizing this current.

Optionally, the power supply device 12 has one or two additional detection device(s) 48 for the continuous or quasi-continuous detection of a current flowing through the reference potential connection 26, and/or through the voltage potential connection 28. This additional detection device 48 is connected with the control and/or regulating unit 22 in a signal technical manner by means of a signal transmission path 50 for transmitting a signal characterizing this current.

Furthermore, the power supply device 12 has (at least) one interface 54 connected with the control and/or regulating unit 22 in a signal technical manner by means of a signal transmission path 52. By means of this interface 54, the control and/or regulating unit 22 may assume control and regulating functions within the power network 14 supplied by the power supply device 12. For this purpose the control and/or regulating unit 22 may be connected with a higher instance of the power network 14, or the system, and/or with the control systems (the control devices 56) of the electric devices 16 switched in the power network 14, such as electric machines, in a signal technical manner via the interface 54.

Finally, the power supply device 12 shown in the FIGURE has a output unit 58 connected with the control and/or regulating unit 22 in a signal technical manner. The same is embodied as a display.

The following functions and advantages are the result:

The insulation state of the entire power supply system 10 is monitored by means of the power supply device 12 for the supply of electric components in a power network 14, in particular the monitoring with regard to multiple grounds in the power network 14, or with regard to a “first system error” in the power network 14 by means of fault currents via the ground conductor (AC/DC insulation measurement, e.g. differential current).

In the example shown in the FIGURE a short-circuit 60 occurs between the first line path 18 and the earth—for example, by means of a fraying of a cable in the electric device 16 at a respective location. In this manner the first line path 18 is connected with the reference potential φ1, not only via the series connection of the short-circuit current path 40 and the earth current path 32, but also via the not provided short-circuit 60 with the earth potential at the additional location. The different locations of the earth potential are in turn electrically connected to each other via a (specific) earth resistance 62 such that an external current circuit 64, a so-called earth loop, is created. For this purpose the external current circuit 64 passes the short-circuit current path 40. In this manner the total current of the external current circuit 64 may be determined by means of determining the current flowing through the short-circuit current path 40. If the detection device 44 is embodied in an all current sensitive manner, the detection will also include the detection of capacitive multiple grounds.

Typical applications include all machines and systems according to the machine directive, which is also applied internationally. These also include areas, in which persons are protected, or systems are installed in an insulated manner.

The power supply 12 is therefore suitable to preventatively detect external currents (e.g. of the external current circuit 64 shown) in the fed power supply system 10, and to provide a superordinate monitoring system, a master display, or a control in the form of a notification.

The power supply device 12 contains the detection device in a connection line between the reference potential connection 26 (e.g. minus pole of a DC supply) and the ground connection 30 connected to the earth, which is at least partly responsible for forming the short-circuit current path 40, such that all currents are detected by this line, and may be analyzed for diagnosis.

As an alternative, the power supply may bring about a current comparison in insulated networks. The current flowing through the voltage potential connection (e.g. the plus clamp) 28 into the power network 14, and the current flowing back via the reference potential connection (the minus clamp) 26, are compared. With such a differential current measurement in turn, a diagnostic signal is provided for service purposes.

These additional detection device 44, 48 may be installed in the device 12 in a fixed manner, or alternatively, the additionally required detection device 44, 48 may be retrofitted as an option.

The introduced power supply device 12 substantially contributes to optimally develop the system availability and initial operation of respective power supply systems 10 in a more professional manner and under EMV aspects. It ensures a significantly higher availability of the systems and leads to enormous savings with initial operations.

List of Reference Symbols

| | |
|---|---|
| Power supply system | 10 |
| Power supply device | 12 |
| Power network | 14 |
| Electric device | 16 |
| First line path | 18 |
| Second line path | 20 |
| Control and/or regulating unit | 22 |
| Power supply unit | 24 |
| Reference potential connection | 26 |
| Voltage potential connection | 28 |
| Ground connection | 30 |
| Ground current path | 32 |
| Current path | 34 |
| Current path | 36 |
| Current path | 38 |
| Short-circuit current path | 40 |
| Switch | 42 |
| Detection device | 44 |
| Signal transmission path | 46 |
| Additional detection device | 48 |
| Signal transmission path | 50 |
| Signal transmission path | 52 |
| Interface | 54 |
| Control device | 56 |
| Output unit | 58 |
| Short-circuit | 60 |
| Earth resistance | 62 |
| External current circuit | 64 |

1. A power supply device having a control and/or regulating unit, a reference potential connection, at least one voltage potential connection, and a ground connection for grounding the power supply device, characterized by a permanent or switchable device internal short-circuit current path between the reference potential connection and the ground connection, by a detection device for the continuous, or quasi-continuous detection of a current flowing through the short-circuit current path, and by a signal transmission path connecting the detection device with the control and/or regulating unit in a signal technical manner.

2. The power supply device of claim 1, wherein the detection device is an all current sensitive detection device, and wherein the dynamics of a continuous or quasi-continuous detection of the detection device comprise a frequency range of 0 Hz to at least 20 kHz.

3. The power supply device of claim 1, wherein the power supply device has at least one additional detection device for the continuous or quasi-continuous detection of a current flowing through at least one of the reference potential connection and the at least one voltage potential connection.

4. The power supply device of claim 1, wherein the control and/or regulating unit monitors a chronological correlation between the current detected in the short-circuit current path, and the detected current flowing through the at least one voltage potential connection in a continuous or quasi-continuous manner.

5. The power supply device according to claim 3, wherein the at least one additional detection device is connected with the control and/or regulating unit in a signal technical manner by means of a further signal transmission path.

6. The power supply device of claim 1, wherein the power supply device has at least one interface that is connected with the control and/or regulating unit in a signal technical manner.

7. The power supply device of claim 6, wherein the at least one interface is embodied as at least one of an analog interface and a digital interface.

8. The power supply device of claim 7, wherein the digital interface is embodied as at least one of a RS232 interface, a RS485 interface, and a RS422 interface.

9. The power supply device of claim 6, wherein the control and/or regulating unit monitors a chronological correlation between the current detected in the short-circuit current path and signals from the at least one interface in a continuous or quasi-continuous manner.

10. The power supply device of claim 1, wherein the control and/or regulating unit is embodied as a microprocessor.

11. The power supply device of claim 1, wherein the power supply device has at least one output unit connected with the control and/or regulating unit in a signal technical manner.

12. The power supply device of claim 11, wherein the at least one output unit is at least one of an optic output unit, and an acoustic output unit, and another interface for the output of a signal to another unit.

13. A power supply system comprising:
a power supply device having a control and/or regulating unit, a reference potential connection, at least one voltage potential connection, and a ground connection for grounding the power supply device, characterized by a permanent or switchable device internal short-circuit current path between the reference potential connection and the ground connection, by a detection device for the continuous, or quasi-continuous detection of a current flowing through the short-circuit current path, and by a signal transmission path connecting the detection device with the control and/or regulating unit in a signal technical manner;
a power network having at least two line paths; and
at least one electric device,
wherein the electric device is supplied with power by the power supply device via the at least two line paths.

14. The power supply system of claim 13, wherein at least one of a control device of the electric device and a control and/or regulating device of the power network is connected with the control and/or regulating unit in a signal technical manner.
